(19) United States
(12) Patent Application Publication
(10) Pub. No.: US 2019/0213618 A1
(43) Pub. Date: Jul. 11, 2019

(54) SECURE REAL-TIME ACCESS TO INCENTIVE DATABASE

(71) Applicant: AMERICAN EXPRESS TRAVEL RELATED SERVICES COMPANY, INC., New York, NY (US)

(72) Inventors: SIMERPREET K. AHLUWALIA, Brampton (CA); RAJESH K. MUNJAL, Scottsdale, AZ (US); BALA RAVINDRAN, Phoenix, AZ (US); ANNE K. SCOTFORD, Scottsdale, AZ (US)

(73) Assignee: AMERICAN EXPRESS TRAVEL RELATED SERVICES COMPANY, INC., New York, NY (US)

(21) Appl. No.: 15/862,897

(22) Filed: Jan. 5, 2018

(51) Int. Cl. G06Q 30/02; H04L 29/08; G06F 17/30

(52) U.S. Cl. CPC G06Q 30/0207; G06F 17/30424; H04L 67/2804; H04L 67/2819

(57) ABSTRACT

A consuming application may transmit a request for customer incentive data to an API proxy. The request may include a request for an existing data value and a derived data value, as well as security credentials indicating the user has permission to obtain the requested data. The API proxy may transmit the request to a customer incentive system, which may retrieve the existing data value and calculate the derived data value in real-time. The requested data may be returned to the consuming application via the API proxy.

### FIELD

This disclosure generally relates to computer systems, and more particularly, to data security and transmissions between computer systems.

### BACKGROUND

Transaction account issuers often provide incentives to corporate customers such as, for example, for opening an account or spending a set amount in a month or quarter. The customer incentive data (e.g., contract details and current spend) are stored in a customer incentive system. However, access to the data in the customer incentive system is typically limited to very few people due to security concerns. Customers may call an account developer to inquire about the status of an account, and the account developer may be limited to providing estimates or pulling data from multiple sources, wherein the sources may not be accurate or up to date. This inaccurate data can lead to customer dissatisfaction.

### SUMMARY

Systems, methods, and articles of manufacture (collectively, the “system”) for providing data security and transmissions between computer systems are disclosed. The system may perform operations including receiving, by an application programming interface (API) proxy and from a consuming application, a request for customer incentive data; transmitting, by the API proxy, the request for customer incentive data to a customer incentive API; transmitting, by the customer incentive API, a get request for an existing data value and a derived data value to a customer incentive system; calculating, by the customer incentive system, the derived data value; transmitting, by the customer incentive system, the existing data value and the derived data value to the customer incentive API; transmitting, by the customer incentive API, the existing data value and the derived data value to the API proxy; and transmitting, by the API proxy, the existing data value and the derived data value to the consuming application.

In various embodiments, the API proxy may comprise a proxy endpoint and a target endpoint. The consuming application may display the existing data value and the derived data value on a web client. The get request may comprise an HTTP request. The request for customer incentive data may comprise a security key indicating user access permissions. The customer incentive system may calculate the derived data value based on at least two existing data values. The customer incentive system may store the get request in a log.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a block diagram illustrating various system components of a system for secure real-time access to customer incentive data, in accordance with various embodiments.

FIG. 2 illustrates a process flow for a method of securely accessing customer incentive data in real-time, in accordance with various embodiments.

FIG. 3 illustrates an example of a consuming application display of customer incentive data, in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The systems may provide account developers secure, real-time access to incentive data in a customer incentive system. The account developers may connect to the customer incentive system using an application programming interface (“API”) proxy in order to review and discuss incentive programs with clients. The API proxy may pull data from the customer incentive system via a customer incentive API in real-time without performing any additional calculations, ensuring the information is as accurate and current as the source system. The customer incentive API may be reused by many different consuming applications. The customer incentive API may leverage existing data security within the consuming application to provide the data residing in the customer incentive system via numerous channels. The customer incentive API provides the same data to both account developers and customers themselves, which decreases discrepancies in the customer incentive data provided to multiple parties.

This process improves the functioning of the computer system. For example, by using the security access protocols of the consuming application, the customer incentive system is able to securely provide customer incentive data without maintaining large access permission files, which saves on data storage and memory which speeds processing. Additionally, the customer incentive API removes the need for point-to-point interface files that over time become costly to maintain. Because the customer incentive API offers customer incentives data on demand in existing tools already used by account developers and customers, there is no need to generate interface files for these systems or other resources consuming the customer incentives data. With the customer incentive API, account developers may pull dashboards on demand without requiring an operations team to create dashboards by combining multiple reports manually. Large amounts of server resources were previously utilized as multiple reports were ran a fetched from servers in order to create the dashboard for account developers. However, the customer incentive API allows the account developer to acquire the calculated incentive data without fetching the large volume of reports. Additionally, by transmitting, storing, and accessing data using the processes described herein, the security of the data is improved, which decreases the risk of the computer or network from being compromised.

The customer incentive API may eliminate the process of account developers and customers extracting, storing, and manipulating data from other application systems and data sources that cannot provide accurate client incentives data. The customer incentive API may also eliminates the need for the operations team to answer questions, e-mail reports or data pulls that are done ad hoc at the request of an account developer. These reductions may save computer processing time and storage space. The customer incentive API provides client incentives data on demand, which may eliminate the elapsed work time and time duration for all of the current manual processes described here.

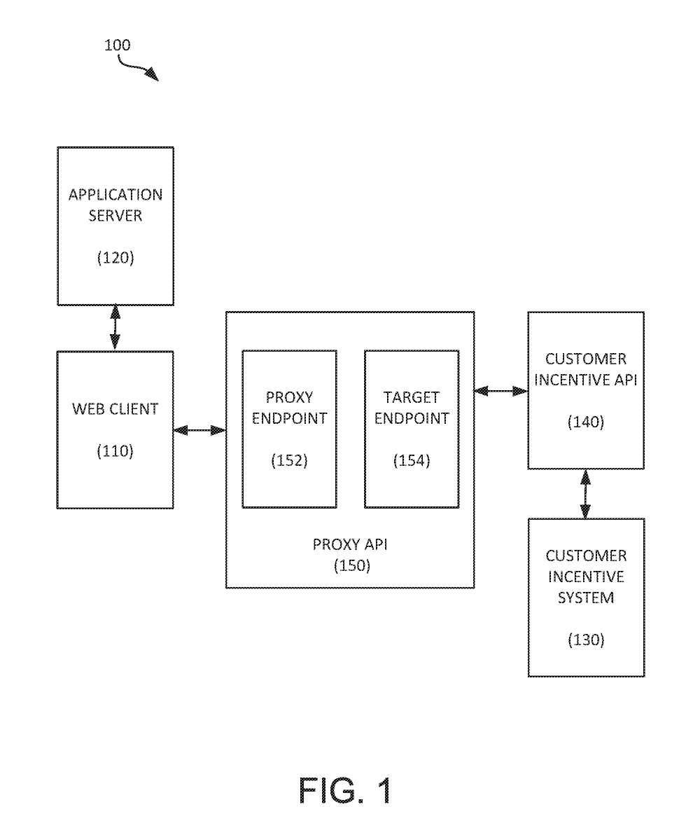

Referring to FIG. 1, a system 100 for secure real-time access to customer incentive data is illustrated according to various embodiments. The system 100 may comprise a web client 110, an application server 120, and a customer incentive system 130. The application server 120 and the customer incentive system 130 may communicate using a customer incentive API 140 and an API proxy 150.

The web client 110 may be a device capable of communication over a network, such as a desktop computer or mobile phone. A user may interact with the web client 110 in order to view customer incentive data stored on the customer incentive system 130. In various embodiments, the user may be a transaction account owner, and the user may wish to view data related to their transaction account which is stored on the customer incentive system 130. In various embodiments, the user may be an employee of a transaction account issuer, and the user may wish to view data for a customer which is stored on the customer incentive system 130. For example, a customer may call an account developer on the phone, and the account developer may use the web client to view and provide customer incentive data to the customer over the phone.

The application server 120 may comprise one or more processors or databases capable of providing digital content to the web client 110. The application server 120 may receive requests from account developers or customers which have transaction accounts with the customer incentive system 130, and the application server 120 may fetch customer incentive data from the customer incentive system 130 and send back the requested data to the web client 110. In various embodiments, the application server 120 may provide any suitable customer relationship management product. The customer relationship management product may include an interface for case management, task management, analytical tools, and/or other services. The customer relationship management product may include access to customers' entitlements and contracts, such as SALESFORCE™ provided by SALESFORCE.COM™ of San Francisco, Calif.

The customer incentive system 130 may comprise one or more processors or databases capable of obtaining and/or storing customer incentive data. For example, the customers may be a business that maintains a master corporate transaction account including multiple transaction accounts for the business's employees. The customer incentive system 130 may store and track transactions, contracts, and other changes to transaction accounts. A transaction account issuer may incentivize a business to sign up for an account by providing a signing bonus, which may be earned if the business spends a set amount within a set period of time. For example, a business may earn a $1,000 credit if the business spends more than $10,000 in the first three months. In various embodiments, the signing bonus may be given upfront, and the transaction account issuer may require the business to pay back the bonus if the spend threshold is not reached in the set amount of time, which is referred to as “clawing back” the bonus. In various embodiments, the business may earn a bonus based on charge volume each month, quarter, year or any other period of time. In various embodiments, the bonuses may be tiered. For example, the business may earn a 1% credit on spend up to $10,000 per month, 2% credit on spend between $10,000 and $100,000 per month, and 2.5% credit on spend over $100,000 each month.

The customer incentive system 130 may store customer incentive data such as contract details, historical incentives detail and current incentives detail. Such data helps to understand past performance, measurement of current progress, and the ability of customers and account developers to make informed decisions on how to position or increase charge volume proactively to maximize the customer's incentives reward amount. The contract details may comprise those items pertinent to the customer's incentive program such as, for example, the contract period, the signing bonus charge volume thresholds, performance bonus charge volume thresholds, the different reward tiers, the different products that are eligible for earning incentives and special high volume charges with special incentives.

The historical data may include, for example, when prior incentives payments were paid, the amount of incentive payments, and whether a signing bonus or performance bonus was obtained. The current data may include actual and forecast incentivized charge volume, how much more charge volume is required to achieve a signing bonus or performance bonus, how much more charge volume is required to achieve the next higher reward tier, client held days incentive or disincentive, deduction amounts, etc.

The customer incentive API 140 and the API proxy 150 may allow the application server 120 to obtain customer incentive data from the customer incentive system 130 and return the customer incentive data to the web client 110. The customer incentive API 140 may communicate directly with the customer incentive system 130.

The API proxy 150 may be implemented on a cloud-based API management platform, such as APIGEE EDGE™ provided by Apigee Corp., of San Jose, Calif. The API proxy 150 may comprise a bundle of XML configuration files and code. The API proxy 150 may comprise a proxy endpoint 152 and a target endpoint 154.

The proxy endpoint 152 may define the way that the consuming application on the application server 120 consumes the customer incentive API 140. The proxy endpoint may be the entry point for a client request. The client security and traffic management policies may be defined at the proxy endpoint 152. The proxy endpoint 152 may define a uniform resource locator (“URL”) of the API proxy 150. The proxy endpoint 154 may determine whether the consuming application accesses the API proxy 150 over HTTP or HTTPS. Policies may be attached to the proxy endpoint 154 to enforce security, quota checks, and other types of access control and rate limiting.

For example, a rate limiting policy may be a spike arrest policy with a transaction velocity limit, such as 180 transactions per minute, such that at no time will more than 3 transactions be allowed per second on any server.

The target endpoint 154 may define the way the API proxy 150 interacts with the customer incentive API 140 and the customer incentive system 130. The target endpoint 154 may define how the API proxy 150 may communicate with the backend service. The backend connection settings, such as HTTPS, 2-way-SSL, and connection timeout may be defined at the target endpoint 154. The target endpoint 154 may forward requests to the customer incentive system 130, including defining security settings, HTTP or HTTPS protocol, and other connection information. Policies may be attached to the target endpoint 154 to ensure that response messages are formatted for the consuming application.

The API proxy 150 and the customer incentive system 130 may communicate utilizing two way secure sockets layer (“SSL”) and/or transport layer security (“TLS”). SSL certificates may be installed on the customer incentive system 130 and the API proxy 150 for the two way TLS handshake between the customer incentive system 130 and the API proxy 150. The certificates may be in .PEM format. The application server 120 and the API proxy 150 may communicate utilizing one way SSL, HMAC authorization, and X-BANK-API-KEY.

A consumer SSL certificate may be installed on the API proxy 150 end for the TLS handshake to take place between the two when the request is sent from the customer to the API proxy 150. For HMAC authorization, each customer may need to get the client key and secret from the API platform during the onboarding process. The X-BANK-API-KEY is a client identifier or key and is sent in the header. The API management gateway may support the HMAC security model. The HMAC token is used to access HTTP API endpoints. The HMAC token may be generated from the client_id and client_secret provided to the customer during registration.

The system 100 may utilize single sign-on authentication. The user of the web client 110 (e.g., an account developer, customer, or other) may enter login credentials into the web client 110 which are authenticated by the application server 120. The application server 120 may control the user's access to data. For example, the application server 120 may limit an account developer to view data associated with the account developer's clients. When requesting customer incentive data from the customer incentive system 130, the application server 120 may pass the user's credential information to the proxy endpoint 152 indicating which data the user is authorized to view. The proxy endpoint 152 may receive the identifications of customers which the user is authorized to view from the consuming application. For example, account developers may login to a consuming application and only see the clients and accounts which they are authorized to view. The account developer may select a particular client and call the API to view incentive details for that client.

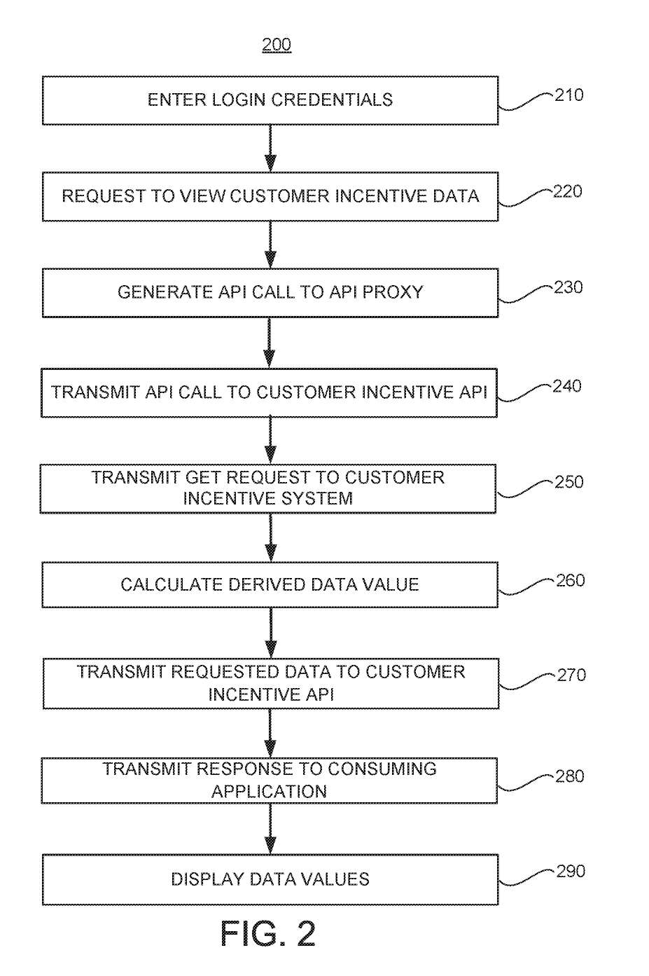

Referring to FIG. 2, a flowchart 200 of a process for secure real-time access to customer incentive data is illustrated, according to various embodiments. A user may enter login credentials to a consuming application (step 210). For example, the user may enter a user name and a password in a graphical user interface of a web client. In various embodiments, the consuming application may be a customer relationship management product. The consuming application may have stored access permissions for the user, indicating which customers' data the user may access. The user may input a request to view customer incentive data stored in a customer incentive system (step 220). In various embodiments, the input may comprise at least one of selecting a link, clicking a button, swiping an item on a graphical user interface, typing or speaking a command, etc. The incentive data may be integrated into the application and displayed seamlessly based on how the application is used by the user. When the user logs in to the application and selects a client, they may see an option to view incentives data. On selecting this option, the application will request the data from the customer incentive system, and the response may be displayed to the user with the latest Incentives data. Clicking a button in the consuming application may call the consumer incentive API.

The consuming application may generate and transmit an API call to a proxy endpoint on an API proxy (step 230). The API call may include input parameters specified by the proxy endpoint. For example, the API call may include a user ID, a customer ID, a security key indicating the user's access permissions, and requested data fields. The proxy endpoint may pass the API call to the target endpoint. All data in a requires may be passed unchanged from the proxy endpoint to the target endpoint. Therefore, when the target endpoint makes the request to the backend server, all information in the original request may be passed to the backend service. The target endpoint may pass the API call to the customer incentive API (step 240). The customer incentive API may be organized around REST with JSON responses. The customer incentive API may have predictable, resource-oriented URLs and use built-in HTTP features including authentication, response codes, and verbs.

The customer incentive API may transmit an HTTP get request to the customer incentive system (step 250). The customer incentive system may store data values for thousands of fields and millions of customers, referred to as existing data fields or existing data values. The get request may indicate which data fields for which customers should be retrieved. The get request may also request derived data values for data fields which are not present in the customer incentive system. For example, the get request may provide a formula to the customer incentive system to calculate a derived data value from one or more data fields present in the customer incentive system. In various embodiments, the customer incentive system may store a first data field for the current monthly spend, and a second data field for the minimum monthly spend necessary to earn a bonus. The get request may request a derived data value for the difference between the minimum monthly spend necessary to earn a bonus and the current monthly spend.

The customer incentive system may calculate the derived data values (step 260). For example, the customer incentive system may subtract the current monthly spend from the minimum monthly spend in order to calculate the derived data value requested by the customer incentive API. The customer incentive system may log each request received from the customer incentive API and store all information associated with the request. The customer incentive system may transmit the requested data values and derived data values to the customer incentive API (step 270). Thus, the customer incentive API may obtain both existing data values and derived data values from the customer incentive system in real-time without the customer incentive API performing any calculations (or minimal calculations). The customer incentive API may transmit a response including the data values to the target endpoint, which in turn transmits the response to the proxy endpoint, which in turn transmits the response to the consuming application (step 280). The consuming application may then display the data values on the web client of the user (step 290). If the user is the customer, the customer may view the data values for the customer's own use. If the user is an account developer, the account developer may relay the data values to the customer, such as over a phone. The account developer may use the data values to provide additional ways to enhance customer satisfaction, such as by notifying the customer that they may obtain an additional bonus if particular spend actions are completed (e.g. increasing spend volume, opening additional accounts, etc.) according to the data values retrieved from the customer incentive system.

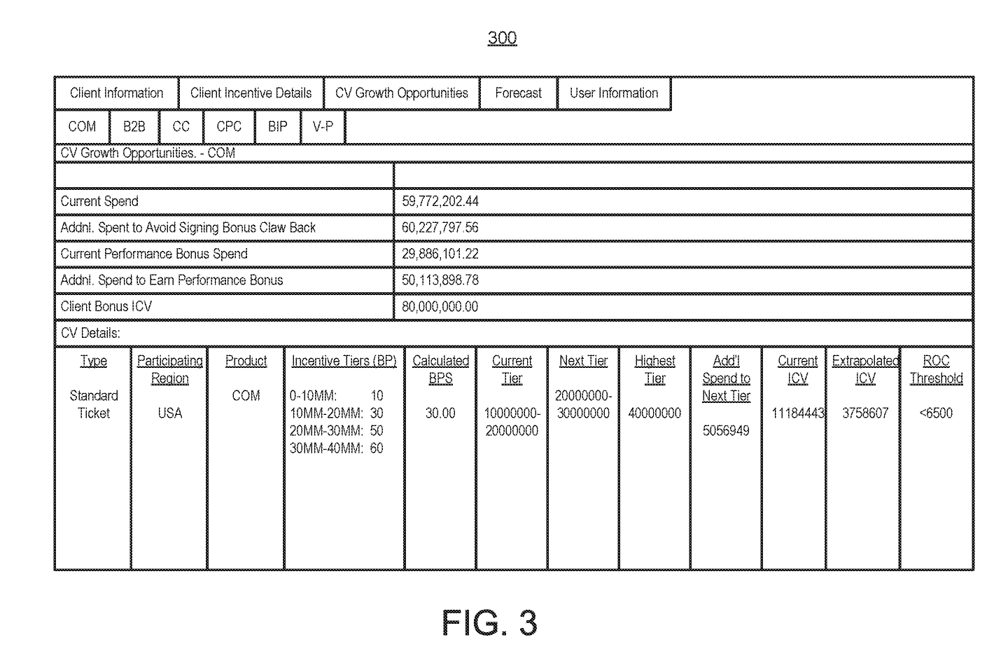

Referring to FIG. 3, an exemplary customer incentive display 300 in a consuming application is illustrated, according to various embodiments. The display 300 may display the data values returned from the customer incentive system. The customer incentive display may segment the retrieved data values in different tabs to simplify the presentation of the information. In various embodiments, the customer incentive display may include a customer information tab, a customer incentive details tab, a customer growth opportunity tab, a forecast tab, and a user information tab.

As shown in FIG. 3, the growth opportunity tab may display both existing data values from the customer incentive system, as well as derived data values calculated in real-time by the customer incentive system in response to an API call. For example, the existing data values may include a current spend and a current performance bonus spend. The current spend may indicate how much the customer has spent in an introductory period toward an upfront signing bonus. The current performance bonus spend may indicate how much the customer has spent during the current charge cycle. The derived data values may include the additional spend to avoid signing bonus clawback and the additional spend to earn a performance bonus. Thus, the customer incentive display 300 may quickly and accurately present users with real-time data stored in the customer incentive database, as well as insightful derived values calculated based on the data stored in the customer incentive database.

By using the API proxy as described herein, a user of a consuming application may securely obtain customer incentive data (e.g., accurate and/or real-time data) stored in a customer incentive system with one click (or few clicks) and without requiring the customer incentive system to maintain a large user permissions table. Additionally, the proxy API is easily utilized by multiple types of consuming applications without onerous changes to the system.

Systems, methods and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy,” “meet,” “match,” “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at predetermined intervals, periodic, randomly, once, more than once, or in response to a suitable request or action. Any of the information may be distributed and/or accessed via a software enabled link, wherein the link may be sent via an email, text, post, social network input and/or any other method known in the art.

The system or any components may integrate with system integration technology such as, for example, the ALEXA system developed by AMAZON. Alexa is a cloud-based voice service that can help you with tasks, entertainment, general information and more. All Amazon Alexa devices, such as the Amazon Echo, Amazon Dot, Amazon Tap and Amazon Fire TV, have access to the Alexa Voice Service. The system may receive voice commands via its voice activation technology, and activate other functions, control smart devices and/or gather information. For example, music, emails, texts, calling, questions answered, home improvement information, smart home communication/activation, games, shopping, making to-do lists, setting alarms, streaming podcasts, playing audiobooks, and providing weather, traffic, and other real-time information, such as news. The system may allow the user to access information about eligible accounts linked to an online account across all Alexa-enabled devices.

The customer may be identified as a customer of interest to a merchant based on the customer's transaction history at the merchant, types of transactions, type of transaction account, frequency of transactions, number of transactions, lack of transactions, timing of transactions, transaction history at other merchants, demographic information, personal information (e.g., gender, race, religion), social media or any other online information, potential for transacting with the merchant and/or any other factors.

The phrases consumer, customer, user, account holder, account affiliate, cardmember or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

A distributed computing cluster used in conjunction with big data sets may be, for example, a Hadoop® cluster configured to process and store big data sets with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/. For more information on big data management systems, see U.S. Ser. No. 14/944,902 titled INTEGRATED BIG DATA INTERFACE FOR MULTIPLE STORAGE TYPES and filed on Nov. 18, 2015; U.S. Ser. No. 14/944,979 titled SYSTEM AND METHOD FOR READING AND WRITING TO BIG DATA STORAGE FORMATS and filed on Nov. 18, 2015; U.S. Ser. No. 14/945,032 titled SYSTEM AND METHOD FOR CREATING, TRACKING, AND MAINTAINING BIG DATA USE CASES and filed on Nov. 18, 2015; U.S. Ser. No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Ser. No. 14/944,898 titled SYSTEMS AND METHODS FOR TRACKING SENSITIVE DATA IN A BIG DATA ENVIRONMENT and filed on Nov. 18, 2015; and U.S. Ser. No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE®.pdf document, etc.), an “ebook,” an “emagazine,” an application or microapplication (as described herein), an SMS or other type of text message, an email, Facebook, Twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

A “consumer profile” or “consumer profile data” may comprise any information or data about a consumer that describes an attribute associated with the consumer (e.g., a preference, an interest, demographic information, personally identifying information, and the like).

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by Artificial Intelligence (AI) or Machine Learning. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory or in-memory (non-spinning) hard drives. A removable storage unit includes a computer usable storage medium having stored therein computer software and/or data.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS, EDB® Postgres Plus Advanced Server® (PPAS), etc.). In various embodiments, the server may include web servers (e.g. APACHE, IIS, GWS, SUN JAVA® SYSTEM WEB SERVER, JAVA Virtual Machine running on LINUX or WINDOWS).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS®/CE/Mobile, OS2, UNIX®, LINUX®, SOLARIS®, MacOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16 bit integers.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

The terms “payment vehicle,” “transaction account”, “financial transaction instrument,” “transaction instrument” and/or the plural form of these terms may be used interchangeably throughout to refer to a financial instrument. Phrases and terms similar to “transaction account” may include any account that may be used to facilitate a financial transaction.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA® 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

Phrases and terms similar to an “item” or “product” may include any good, service, information, experience, entertainment, data, offer, discount, rebate, points, virtual currency, content, access, rental, lease, contribution, account, credit, debit, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

Any databases discussed herein may include relational, hierarchical, graphical, blockchain, object-oriented structure and/or any other database configurations. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), MongoDB®, Redis®, Apache Cassandra®, HBase by APACHE®, MapR-DB, or any other suitable database product. Moreover, the databases may be organized in any suitable manner, for example, as data tables or lookup tables. Each record may be a single file, a series of files, a linked series of data fields or any other data structure.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

As stated above, in various embodiments, the data can be stored without regard to a common format. However, the data set, e.g. a binary large object (BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference. For example, representational state transfer (REST), or RESTful, web services may provide one way of enabling interoperability between applications.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, JAVASCRIPT Object Notation (JSON), VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

In various embodiments, the software elements of the system may also be implemented using Node.js®. Node.js® may implement several modules to handle various core functionalities. For example, a package management module, such as Npm®, may be implemented as an open source library to aid in organizing the installation and management of third-party Node.js® programs. Node.js® may also implement a process manager, such as, for example, Parallel Multithreaded Machine (“PM2”); a resource and performance monitoring tool, such as, for example, Node Application Metrics (“appmetrics”); a library module for building user interfaces, such as for example ReachJS®; and/or any other suitable and/or desired module.

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet®, Veriphone®, Discover Card®, PayPal®, ApplePay®, GooglePay®, private networks (e.g., department store networks), and/or any other payment networks.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

The process flows and screenshots depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIGS. 2-5, but also to the various system components as described above with reference to FIG. 1.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The terms “payment vehicle,” “transaction account,” “financial transaction instrument,” “transaction instrument” and/or the plural form of these terms may be used interchangeably throughout to refer to a financial instrument. Phrases and terms similar to “transaction account” may include any account that may be used to facilitate a financial transaction.

The disclosure and claims do not describe only a particular outcome of providing a reverse bid, but the disclosure and claims include specific rules for implementing the outcome of providing a reverse bid and that render information into a specific format that is then used and applied to create the desired results of providing a reverse bid, as set forth in McRO, Inc. v. Bandai Namco Games America Inc. (Fed. Cir. case number 15-1080, Sep. 13, 2016). In other words, the outcome of providing a reverse bid can be performed by many different types of rules and combinations of rules, and this disclosure includes various embodiments with specific rules. While the absence of complete preemption may not guarantee that a claim is eligible, the disclosure does not sufficiently preempt the field of providing a reverse bid at all. The disclosure acts to narrow, confine, and otherwise tie down the disclosure so as not to cover the general abstract idea of just providing a reverse bid. Significantly, other systems and methods exist for providing a reverse bid, so it would be inappropriate to assert that the claimed invention preempts the field or monopolizes the basic tools of providing a reverse bid. In other words, the disclosure will not prevent others from providing a reverse bid, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

In various embodiments, the system and method may include a graphical user interface for dynamically relocating/rescaling obscured textual information of an underlying window to become automatically viewable to the user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

In various embodiments, the system may also include isolating and removing malicious code from electronic messages (e.g., email) to prevent a computer from being compromised, for example by being infected with a computer virus. The system may scan electronic communications for malicious computer code and clean the electronic communication before it may initiate malicious acts. The system operates by physically isolating a received electronic communication in a “quarantine” sector of the computer memory. A quarantine sector is a memory sector created by the computer's operating system such that files stored in that sector are not permitted to act on files outside that sector. When a communication containing malicious code is stored in the quarantine sector, the data contained within the communication is compared to malicious code-indicative patterns stored within a signature database. The presence of a particular malicious code-indicative pattern indicates the nature of the malicious code. The signature database further includes code markers that represent the beginning and end points of the malicious code. The malicious code is then extracted from malicious code-containing communication. An extraction routine is run by a file parsing component of the processing unit. The file parsing routine performs the following operations: scan the communication for the identified beginning malicious code marker; flag each scanned byte between the beginning marker and the successive end malicious code marker; continue scanning until no further beginning malicious code marker is found; and create a new data file by sequentially copying all non-flagged data bytes into the new file, which thus forms a sanitized communication file. The new, sanitized communication is transferred to a non-quarantine sector of the computer memory. Subsequently, all data on the quarantine sector is erased. More particularly, the system includes a method for protecting a computer from an electronic communication containing malicious code by receiving an electronic communication containing malicious code in a computer with a memory having a boot sector, a quarantine sector and a non-quarantine sector; storing the communication in the quarantine sector of the memory of the computer, wherein the quarantine sector is isolated from the boot and the non-quarantine sector in the computer memory, where code in the quarantine sector is prevented from performing write actions on other memory sectors; extracting, via file parsing, the malicious code from the electronic communication to create a sanitized electronic communication, wherein the extracting comprises scanning the communication for an identified beginning malicious code marker, flagging each scanned byte between the beginning marker and a successive end malicious code marker, continuing scanning until no further beginning malicious code marker is found, and creating a new data file by sequentially copying all non-flagged data bytes into a new file that forms a sanitized communication file; transferring the sanitized electronic communication to the non-quarantine sector of the memory; and deleting all data remaining in the quarantine sector.

In various embodiments, the system may also address the problem of retaining control over customers during affiliate purchase transactions, using a system for co-marketing the “look and feel” of the host web page with the product-related content information of the advertising merchant's web page. The system can be operated by a third-party outsource provider, who acts as a broker between multiple hosts and merchants. Prior to implementation, a host places links to a merchant's webpage on the host's web page. The links are associated with product-related content on the merchant's web page. Additionally, the outsource provider system stores the “look and feel” information from each host's web pages in a computer data store, which is coupled to a computer server. The “look and feel” information includes visually perceptible elements such as logos, colors, page layout, navigation system, frames, mouse-over effects or other elements that are consistent through some or all of each host's respective web pages. A customer who clicks on an advertising link is not transported from the host web page to the merchant's web page, but instead is re-directed to a composite web page that combines product information associated with the selected item and visually perceptible elements of the host web page. The outsource provider's server responds by first identifying the host web page where the link has been selected and retrieving the corresponding stored “look and feel” information. The server constructs a composite web page using the retrieved “look and feel” information of the host web page, with the product-related content embedded within it, so that the composite web page is visually perceived by the customer as associated with the host web page. The server then transmits and presents this composite web page to the customer so that she effectively remains on the host web page to purchase the item without being redirected to the third party merchant affiliate. Because such composite pages are visually perceived by the customer as associated with the host web page, they give the customer the impression that she is viewing pages served by the host. Further, the customer is able to purchase the item without being redirected to the third party merchant affiliate, thus allowing the host to retain control over the customer. This system enables the host to receive the same advertising revenue streams as before but without the loss of visitor traffic and potential customers. More particularly, the system may be useful in an outsource provider serving web pages offering commercial opportunities. The computer store containing data, for each of a plurality of first web pages, defining a plurality of visually perceptible elements, which visually perceptible elements correspond to the plurality of first web pages; wherein each of the first web pages belongs to one of a plurality of web page owners; wherein each of the first web pages displays at least one active link associated with a commerce object associated with a buying opportunity of a selected one of a plurality of merchants; and wherein the selected merchant, the outsource provider, and the owner of the first web page displaying the associated link are each third parties with respect to one other; a computer server at the outsource provider, which computer server is coupled to the computer store and programmed to: receive from the web browser of a computer user a signal indicating activation of one of the links displayed by one of the first web pages; automatically identify as the source page the one of the first web pages on which the link has been activated; in response to identification of the source page, automatically retrieve the stored data corresponding to the source page; and using the data retrieved, automatically generate and transmit to the web browser a second web page that displays: information associated with the commerce object associated with the link that has been activated, and the plurality of visually perceptible elements visually corresponding to the source page.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

What is claimed is:

1. A method, comprising:
receiving, by an application programming interface (API) proxy and from a consuming application, a request for customer incentive data;
transmitting, by the API proxy, the request for customer incentive data to a customer incentive API;
transmitting, by the customer incentive API, a get request for an existing data value and a derived data value to a customer incentive system;
calculating, by the customer incentive system, the derived data value;
transmitting, by the customer incentive system, the existing data value and the derived data value to the customer incentive API;
transmitting, by the customer incentive API, the existing data value and the derived data value to the API proxy; and
transmitting, by the API proxy, the existing data value and the derived data value to the consuming application.

2. The method of claim 1, wherein the API proxy comprises a proxy endpoint and a target endpoint.

3. The method of claim 1, wherein the consuming application displays the existing data value and the derived data value on a web client.

4. The method of claim 1, wherein the get request comprises an HTTP request.

5. The method of claim 1, wherein the request for customer incentive data comprises a security key indicating user access permissions.

6. The method of claim 1, wherein the customer incentive system calculates the derived data value based on at least two existing data values.

7. The method of claim 1, further comprising storing, by the customer incentive system, the get request in a log.

8. A system comprising:
a processor,
a tangible, non-transitory memory configured to communicate with the processor,
the tangible, non-transitory memory having instructions stored thereon that, in response to execution by the processor, cause the processor to perform operations comprising:
receiving, by a customer incentive system, a get request for an existing data value and a derived data value from a customer incentive application programming interface (API), wherein the get request is based on a request for customer incentive data received from an API proxy;
calculating, by the customer incentive system, the derived data value; and
transmitting, by the customer incentive system, the existing data value and the derived data value to the customer incentive API,
wherein the customer incentive API transmits the existing data value and the derived data value to the API proxy, and
wherein the API proxy transmits the existing data value and the derived data value to a consuming application.

9. The system of claim 8, wherein the API proxy comprises a proxy endpoint and a target endpoint.

10. The system of claim 8, wherein the consuming application displays the existing data value and the derived data value on a web client.

11. The system of claim 8, wherein the get request comprises an HTTP request.

12. The system of claim 8, wherein the request for customer incentive data comprises a security key indicating user access permissions.

13. The system of claim 8, wherein the customer incentive system calculates the derived data value based on at least two existing data values.

14. The system of claim 8, further comprising storing, by the customer incentive system, the get request in a log.

15. An article of manufacture including a non-transitory, tangible computer readable storage medium having instructions stored thereon that, in response to execution by a computer-based system, cause the computer-based system to perform operations comprising:
receiving, by an application programming interface (API) proxy and from a consuming application, a request for customer incentive data;
transmitting, by the API proxy, the request for customer incentive data to a customer incentive API;
transmitting, by the customer incentive API, a get request for an existing data value and a derived data value to a customer incentive system;
calculating, by the customer incentive system, the derived data value;
transmitting, by the customer incentive system, the existing data value and the derived data value to the customer incentive API;
transmitting, by the customer incentive API, the existing data value and the derived data value to the API proxy; and
transmitting, by the API proxy, the existing data value and the derived data value to the consuming application.

16. The article of manufacture of claim 15, wherein the API proxy comprises a proxy endpoint and a target endpoint.

17. The article of manufacture of claim 15, wherein the consuming application displays the existing data value and the derived data value on a web client.

18. The article of manufacture of claim 15, wherein the get request comprises an HTTP request.

19. The article of manufacture of claim 15, wherein the request for customer incentive data comprises a security key indicating user access permissions.

20. The article of manufacture of claim 15, wherein the customer incentive system calculates the derived data value based on at least two existing data values.
